(19) United States
(12) Patent Application Publication
(10) Pub. No.: US 2009/0061753 A1
(43) Pub. Date: Mar. 5, 2009

(54) SYSTEM FOR COOLING ENGINE ELECTRONICS

(75) Inventors: James R. Yurgil, Livonia, MI (US); Gary E. Mc Gee, Oxford, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., DETROIT, MI (US)

(21) Appl. No.: 11/950,564

(22) Filed: Dec. 5, 2007

Related U.S. Application Data
(60) Provisional application No. 60/969,308, filed on Aug. 31, 2007.

(51) Int. Cl. B60H 1/32

(52) U.S. Cl. 454/75

(57) ABSTRACT

A temperature control system for a vehicle comprises a coolant comparison module, a component comparison module, and a cooling fan control module. The coolant comparison module generates a coolant status signal having a first state when a coolant temperature is greater than a first threshold. The component comparison module generates a component status signal having a second state when an electronic component temperature is greater than a second threshold. The cooling fan control module selectively activates a cooling fan when at least one of the coolant status signal has the first state and the component status signal has the second state.

### CROSS-REFERENCE TO RELATED APPLICATIONS

This application claims the benefit of U.S. Provisional Application No. 60/969,308, filed on Aug. 31, 2007. The disclosure of the above application is incorporated herein by reference in its entirety.

### FIELD

The present disclosure relates to internal combustion engines, and more particularly to controlling engine cooling fans.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The combustion process within an internal combustion engine generates a significant amount of heat. Excessive heat may reduce the reliability of the engine and/or engine components. Furthermore, excessive heat may shorten the lifetime (i.e., period of reliable use) of the engine and/or the engine components.

Typically, vehicles that include an internal combustion engine also include a heat exchanger (e.g., a radiator) that is connected to coolant channels within the engine. Fluid (e.g., engine coolant) circulates through the coolant channels and the radiator. The engine coolant absorbs heat from the engine and carries the heat to the radiator. The radiator transfers the heat from the engine coolant to air passing the radiator by, for example, convection. In this manner, the engine is cooled.

Vehicles may also include a cooling fan to aid in cooling the engine and the engine components. For example, the cooling fan may cool the engine, and more directly the engine coolant, by increasing the amount of air passing the radiator. The cooling fan may be activated (i.e., turned ON) when the temperature of the engine coolant reaches a temperature threshold. In this manner, the cooling fan may aid in preventing the engine and the engine coolant from being damaged by excessive heat.

### SUMMARY

A temperature control system for a vehicle comprises a coolant comparison module, a component comparison module, and a cooling fan control module. The coolant comparison module generates a coolant status signal having a first state when a coolant temperature is greater than a first threshold. The component comparison module generates a component status signal having a second state when an electronic component temperature is greater than a second threshold. The cooling fan control module selectively activates a cooling fan when at least one of the coolant status signal has the first state and the component status signal has the second state.

In other features, the electronic component temperature is a temperature of a belt alternator starter. The coolant comparison module generates the coolant status signal having a third state when the coolant temperature is less than a third threshold, the component comparison module generates the component status signal having a fourth state when the electronic component temperature is less than a fourth threshold, wherein the third threshold is less than the first threshold and the fourth threshold is less than the second threshold, and the cooling fan control module deactivates the cooling fan when the coolant status signal has the third state and the component status signal has the fourth state.

In further features, the cooling fan control module selectively activates the cooling fan based upon a speed of the vehicle. The cooling fan control module selectively activates the cooling fan when the speed is less than a speed threshold and at least one of the coolant status signal has the first state and the component status signal has the second state.

In still further features, the component comparison module receives a plurality of electronic component temperatures including the electronic component temperature. The component comparison module determines a hottest temperature of the plurality of electronic component temperatures and generates the component status signal having the second state when the hottest temperature is greater than the second threshold.

In other features, the temperature control system further comprises one or more additional component comparison modules that each respectively receive an electronic component temperature, that each have a respective second threshold, and that each generate a respective component status signal having the second state when the respective received electronic component temperature is greater than the respective second threshold, wherein the cooling fan control module activates the cooling fan when at least one of the coolant status signal has the first state, the component status signal has the second state, and any of the respective component status signals has the second state.

A method comprises generating a coolant status signal having a first state when a coolant temperature is greater than a first threshold, generating a component status signal having a second state when an electronic component temperature is greater than a second threshold, and selectively activating a cooling fan in a vehicle when at least one of the coolant status signal has the first state and the component status signal has the second state.

In other features, the method further comprises generating the coolant status signal having a third state when the coolant temperature is less than a third threshold, generating the component status signal having a fourth state when the electronic component temperature is less than a fourth threshold, wherein the third threshold is less than the first threshold and the fourth threshold is less than the second threshold, and deactivating the cooling fan when the coolant status signal has the third state and the component status signal has the fourth state.

In further features, the method further comprises selectively activating the cooling fan based upon a speed of the vehicle. The method further comprises selectively activating the cooling fan when the speed is less than a speed threshold and at least one of the coolant status signal has the first state and the component status signal has the second state.

In still further features, the method further comprises receiving a plurality of electronic component temperatures including the electronic component temperature. The method further comprises determining a hottest temperature of the plurality of electronic component temperatures and generating the component status signal having the second state when the hottest temperature is greater than the second threshold.

In other features, the method further comprises respectively receiving one or more additional electronic component temperatures, that each have a respective second threshold, generating a respective component status signal having the second state for each of the respective received electronic component temperatures when the respective received electronic component temperature is greater than the respective second threshold, and activating the cooling fan when at least one of the coolant status signal has the first state, the component status signal has the second state, and any of the respective component status signals has the second state.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The drawings described herein are for illustration purposes only and are not intended to limit the scope of the present disclosure in any way.

FIG. 1 is a functional block diagram of an exemplary powertrain system according to the principles of the present disclosure;

FIGS. 2A-2B are functional block diagrams of exemplary temperature control modules according to the principles of the present disclosure; and

FIG. 3 is a flowchart depicting exemplary steps performed by a temperature control module according to the principles of the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

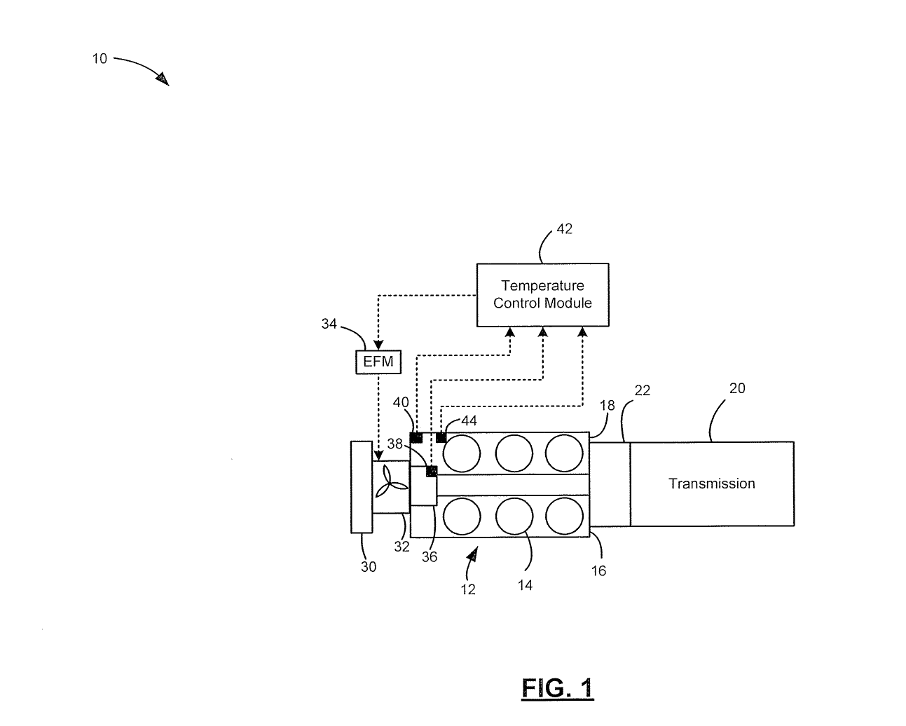

Referring now to FIG. 1, a functional block diagram of an exemplary powertrain system 10 is presented. An engine 12 combusts an air-fuel mixture within one or more cylinders 14 to produce torque. In various implementations, the engine 12 includes six cylinders 14 that are configured in cylinder banks 16 and 18. Although six cylinders 14 are depicted, the engine 12 may include additional or fewer cylinders 14. For example only, the engine 12 may include 2, 4, 5, 8, 10, 12 or 16 cylinders 14. Furthermore, the cylinders 14 of the engine 12 may be configured in any suitable configuration, such as a V-configuration, an inline-configuration, and a flat-configuration.

The engine 12 transfers the torque to a transmission 20. In various implementations, the engine 12 transfers the torque to the transmission 20 via a torque converter 22. The transmission 20 may include a rear-wheel drive transmission, a front-wheel drive transmission, a four-wheel drive transmission, and/or an all-wheel-drive transmission. Furthermore, the transmission 20 may include a manual-type transmission or an automatic-type transmission.

The combustion of the air-fuel mixture within the cylinders 14 generates heat. Fluid (e.g., coolant) circulates through and absorbs heat from the engine 12, thereby cooling the engine 12. The coolant extracts the heat from the engine 12 and carries the heat to a radiator 30. The coolant transfers the heat to air passing the radiator 30 by, for example, convection. In this manner, the air passing the radiator 30 cools the coolant.

Little or no air may pass the radiator 30 when the vehicle 10 is stationary or moving slowly. Accordingly, the coolant may be unable to release heat when the vehicle 10 is stationary or moving slowly. The engine 12 and/or the coolant may be damaged when the coolant is unable to sufficiently release the heat to the air passing the radiator 30.

The vehicle 10 may include a cooling fan 32 that increases airflow passing the radiator 30. Although a single cooling fan 32 is depicted, the vehicle 10 may include more than one cooling fan 32. The cooling fan 32 may be controlled by a cooling fan control signal and may be driven by an electric fan motor (EFM) 34. By increasing the airflow passing the radiator 30, the cooling fan 32 may aid in transferring the heat from the coolant to the air passing the radiator 30. The increased airflow may be especially beneficial in extracting heat from the coolant when the vehicle 10 is stationary or moving slowly.

The cooling fan 32 may also increase airflow within an engine compartment (not shown) of the vehicle 10. Accordingly, the cooling fan 32 may also aid in cooling “under the hood” components associated with the engine 12, such as one or more electronic components 36. The electronic components 36 may include, for example, a motor generator unit, a starter, an ignition system, and/or a belt alternator starter (BAS). The BAS may, for example, shut down the engine 12 when the vehicle 10 is stopped and/or start the engine 12 to accelerate the vehicle 10 from a stop.

A component temperature sensor 38 generates a component temperature signal based upon the temperature of one of the electronic components 36. Although one component temperature sensor 38 is shown, one or more component temperature sensors 38 may be provided for each of the electronic components 36. Although the component temperature sensor 38 is depicted as included within the electronic component 36, the component temperature sensor 38 may be mounted externally to the electronic component 36.

A coolant temperature sensor 40 generates a coolant temperature signal based upon the temperature of the coolant. Although the coolant temperature sensor 40 is depicted as being located within the engine 12, the coolant temperature sensor 40 may be located anywhere that the coolant is contained, such as within the radiator 30.

A temperature control module 42 receives one or more component temperature signals and the coolant temperature signal, collectively referred to as input temperature signals. The temperature control module 42 generates a cooling fan control signal based upon the input temperature signals. Additionally, the temperature control module 42 may generate the cooling fan control signal based upon a vehicle speed signal.

The temperature control module 42 may receive the vehicle speed signal from, for example, a vehicle speed sensor 44. The vehicle speed sensor 44 may generate the vehicle speed signal based upon any suitable measure of vehicle speed, such as engine output speed or transmission output speed.

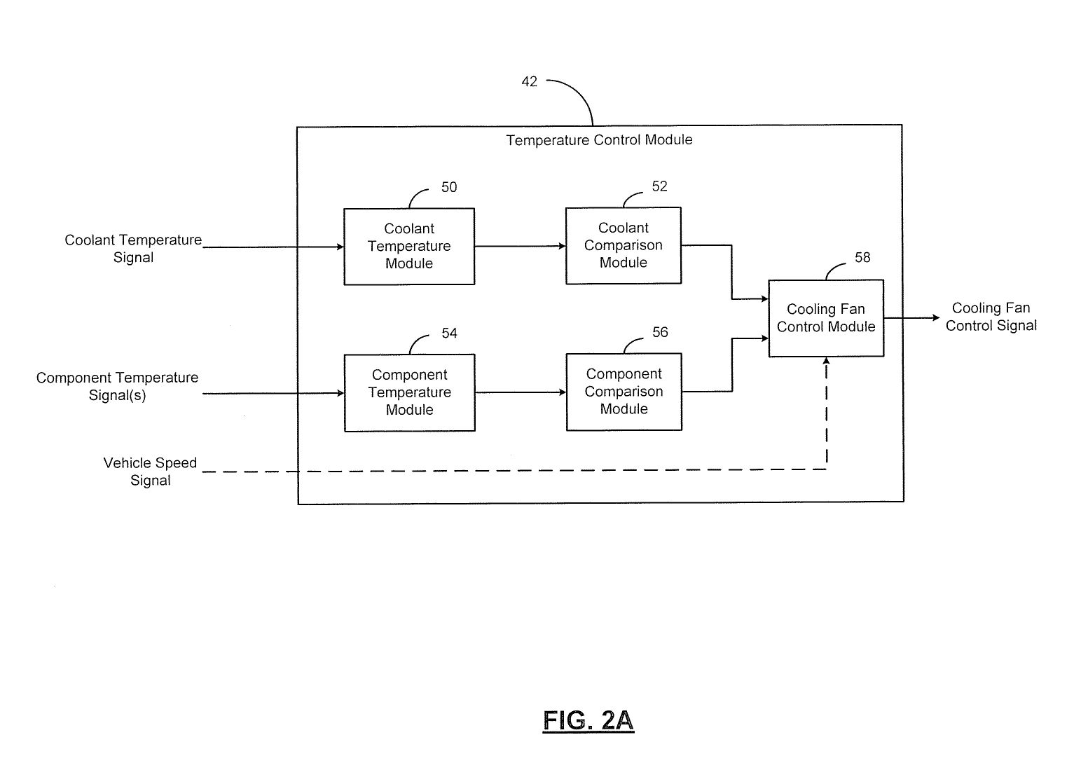

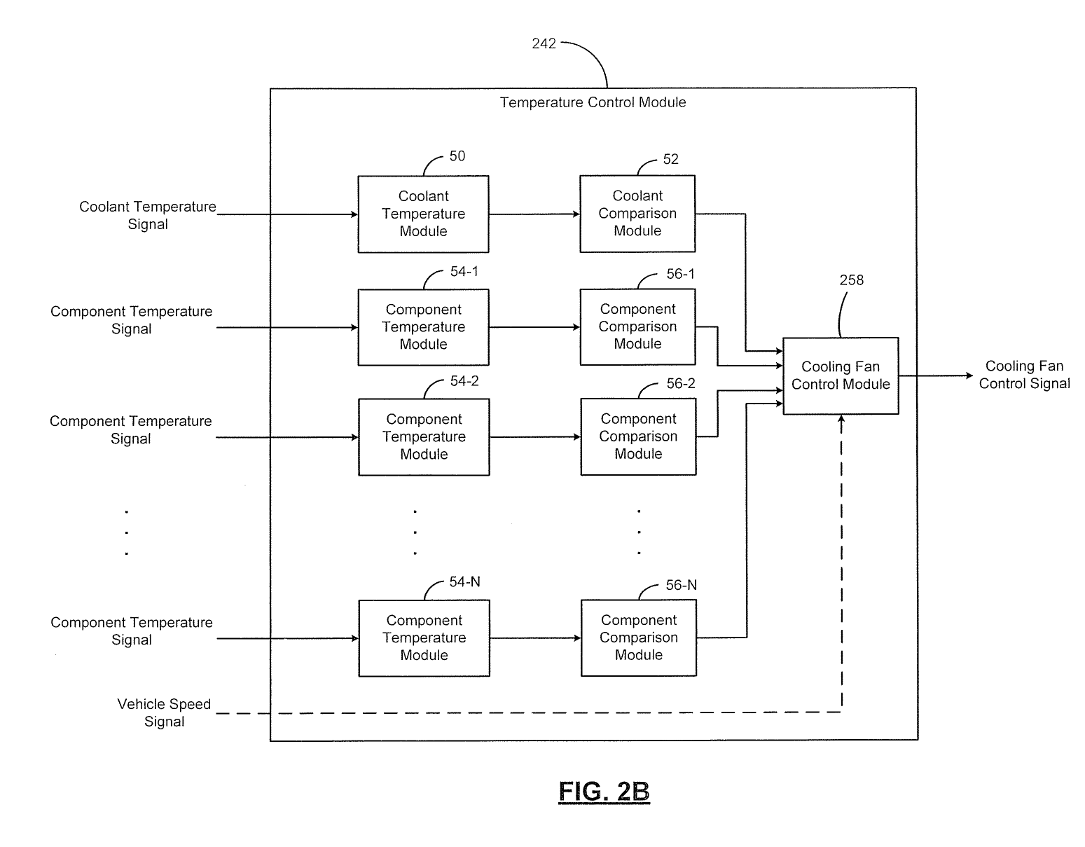

Referring now to FIG. 2A, a functional block diagram of an exemplary implementation of the temperature control module 42 is presented. A coolant temperature module 50 receives the coolant temperature signal from the coolant temperature sensor 40. The coolant temperature module 50 may, for example, filter, buffer, and/or digitize the coolant temperature signal.

The coolant temperature module 50 provides a coolant temperature to a coolant comparison module 52. The coolant comparison module 52 compares the coolant temperature with a maximum coolant temperature threshold (MAXcoolant threshold) and a lower coolant temperature threshold (LOWcoolant threshold). The MAXcoolant and LOWcoolant thresholds may be calibratable. For example only, the MAXcoolant threshold may be set to a temperature above which the engine 12 and/or the coolant may be damaged. The LOWcoolant threshold may be set to a temperature that is less than the MAXcoolant threshold.

The coolant comparison module 52 generates a coolant status signal, which indicates a temperature status of the coolant, such as HOT or COOL. The coolant comparison module 52 may generate the coolant status signal indicating HOT when the coolant temperature is greater than the MAXcoolant threshold. The coolant comparison module 52 may generate the coolant status signal indicating COOL when the coolant temperature is less than the LOWcoolant threshold.

A component temperature module 54 receives the component temperature signal from the component temperature sensor 38. The component temperature module 54 may, for example, filter, buffer, and/or digitize the component temperature signal. The component temperature module 54 may receive multiple component temperature signals, such as when the vehicle 10 includes multiple electronic components 36.

The component temperature module 54 provides one or more component temperatures to a component comparison module 56. The component comparison module 56 may compare each of the component temperatures with a maximum component temperature threshold (MAXcomponent threshold) and a lower component temperature threshold (LOWcomponent threshold). The MAXcomponent and the LOWcomponent thresholds may be calibratable. For example only, the MAXcomponent threshold may be set to a temperature within a reliable operating temperature range of the electronic component 36. The LOWcomponent threshold may be set to a temperature that is less than the MAXcomponent threshold.

The component comparison module 56 generates a component status signal, which indicates a temperature status of the electronic component(s) 36, such as HOT or COOL. For example only, the component comparison module 56 may generate the component status signal indicating HOT when the temperature of any of the electronic components 36 is greater than the MAXcomponent threshold. The component comparison module 56 may generate the component status signal indicating COOL when the temperature of each of the electronic components 36 is less than the LOWcomponent threshold.

Alternatively, the component comparison module 56 may generate the component status signal based upon a comparison of a hottest temperature of the electronic components 36 with the MAXcomponent and LOWcomponent thresholds. The component comparison module 56 may determine the hottest temperature based upon, for example, a comparison of the temperatures of each of the electronic components 36. For example only, the component comparison module 56 may generate the component status signal indicating HOT when the hottest temperature is greater than the MAXcomponent threshold. The component comparison module 56 may generate the component status signal indicating COOL when the hottest temperature is less than the LOWcomponent threshold.

A cooling fan control module 58 generates a cooling fan control signal, such as ON or OFF, based upon the coolant status signal and the component status signal. For example only, the cooling fan control module 58 generates the cooling fan ON signal to activate the cooling fan 32 and generates the cooling fan OFF signal to deactivate the cooling fan 32.

The cooling fan control module 58 may generate the cooling fan ON signal when the coolant status signal and/or the component status signal indicates HOT. The cooling fan control module 58 may generate the cooling fan OFF signal when both the coolant status signal and the component status signal indicate COOL. The cooling fan control module 58 may then wait to generate the cooling fan ON signal again until the coolant status signal and/or the component status signal indicate HOT. In various implementations, the cooling fan control module 58 may limit generating the cooling fan ON signal to times when the vehicle speed is below a speed threshold. For example only, the speed threshold may be approximately thirty-five miles per hour.

The LOWcoolant may be set such that a significant temperature difference exists between the LOWcoolant and MAXcoolant thresholds. Furthermore, the LOWcomponent threshold may be set such that a significant temperature difference exist between the LOWcomponent and MAXcomponent thresholds. These temperature differences may prevent rapid transitions between activating and deactivating the cooling fan 32. Also, these temperature differences may ensure that the coolant and the electronic component(s) 36 are at temperatures safely away from damaging temperatures before the cooling fan 32 is deactivated.

Referring now to FIG. 2B, a functional block diagram of another exemplary implementation of the temperature control module 242 is presented, for a vehicle having multiple component temperature sensors 38. The temperature control module 242 may include multiple component temperature modules 54-1, 54-2, . . . 54-N and component comparison modules 56-1, 56-2, . . . 56-N. N may be equal to the total number of component temperature sensors 38 for all of the electronic components 36. Alternatively, N may be equal to the number of electronic components 36.

The component temperature modules 54-1, 54-2, . . . 54-N each provide a component temperature to one of the component comparison modules 56-1, 56-2, . . . 56-N, respectively. The component comparison modules 56-1, 56-2, . . . 56-N each generate a component status signal, indicating a temperature status of the corresponding electronic component 36.

The cooling fan control module 258 receives the coolant status signal from the coolant comparison module 52 and the component status signals from the component comparison modules 56-1, 56-2, . . . 56-N. The cooling fan control module 258 may generate the cooling fan ON signal when the coolant status signal and/or any of the component status signals indicate HOT. The cooling fan control module 258 may generate the cooling fan OFF signal when the coolant status signal and each of the component status signals indicate COOL.

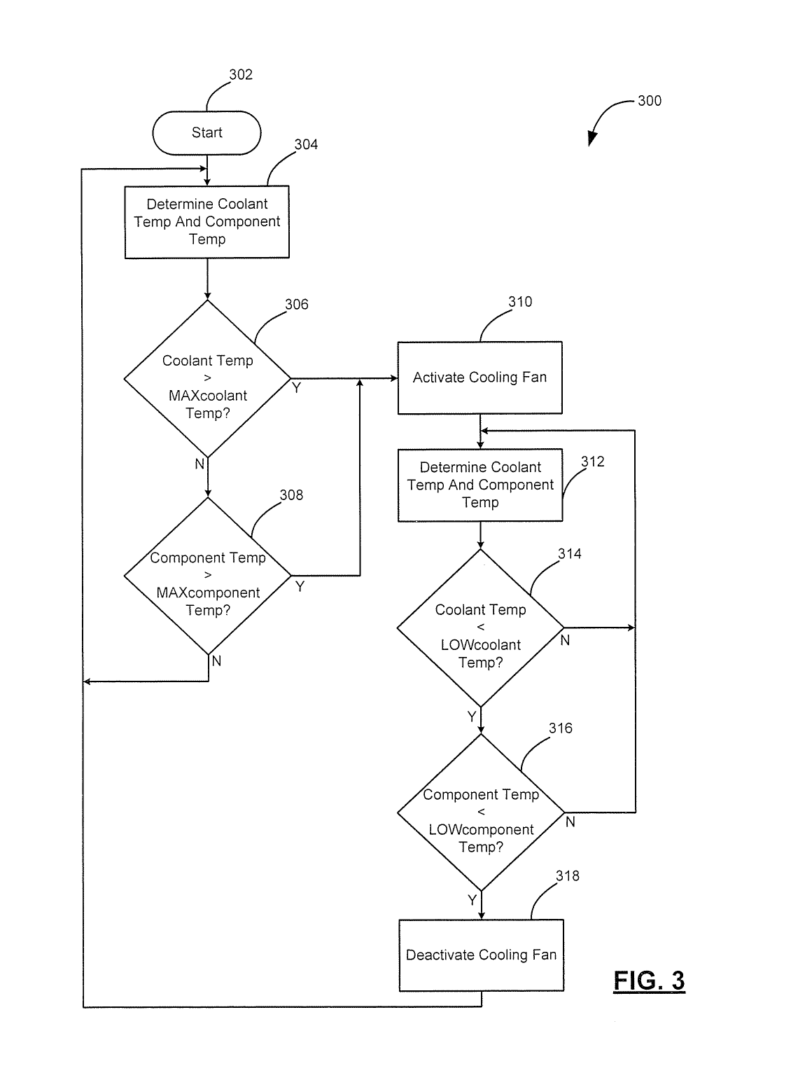

Referring now to FIG. 3, a flowchart depicting exemplary steps performed by the temperature control module 42 is presented. Control begins in step 302 upon starting the engine 12. Control then continues in step 304 where control determines the temperature of the coolant and the temperature of the electronic component 36.

Control continues in step 306 where control compares the temperature of the coolant with the MAXcoolant threshold. If the coolant temperature is greater than the MAXcoolant threshold, control transfers to step 310; otherwise, control continues in step 308. In step 308, control compares the temperature of the electronic component 36 with the MAXcomponent threshold. If the temperature of the electronic component 36 is greater than the MAXcomponent threshold, control transfers to step 310; otherwise, control returns to step 304.

In step 310, control activates the cooling fan 32, and control continues in step 312. In step 312, control again determines the temperature of the coolant and the temperature of the electronic component 36. Control continues in step 314 where control compares the coolant temperature with the LOWcoolant threshold. If the coolant temperature is less than the LOWcoolant threshold, control continues in step 316; otherwise, control returns to step 312 and the cooling fan 32 remains activated.

In step 316, control compares the temperature of the electronic component 36 with the LOWcomponent threshold. If the temperature of the electronic component 36 is less than the LOWcomponent threshold, control continues in step 318; otherwise, control returns to step 312 and the cooling fan 32 remains activated.

In step 318, control deactivates the cooling fan 32, and control returns to step 304. In various implementations, shutting down the engine 12 will not deactivate the cooling fan 32. In such implementations, the cooling fan 32 may remain activated until the coolant and component temperature are both less than their respective thresholds.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A temperature control system for a vehicle, comprising:
a coolant comparison module that generates a coolant status signal having a first state when a coolant temperature is greater than a first threshold;
a component comparison module that generates a component status signal having a second state when an electronic component temperature is greater than a second threshold; and
a cooling fan control module that selectively activates a cooling fan when at least one of said coolant status signal has said first state and said component status signal has said second state.

2. The temperature control system of claim 1 wherein said electronic component temperature is a temperature of a belt alternator starter.

3. The temperature control system of claim 1 wherein:
said coolant comparison module generates said coolant status signal having a third state when said coolant temperature is less than a third threshold;
said component comparison module generates said component status signal having a fourth state when said electronic component temperature is less than a fourth threshold;
said third threshold is less than said first threshold and said fourth threshold is less than said second threshold; and
said cooling fan control module deactivates said cooling fan when said coolant status signal has said third state and said component status signal has said fourth state.

4. The temperature control system of claim 1 wherein said cooling fan control module selectively activates said cooling fan based upon a speed of said vehicle.

5. The temperature control system of claim 4 wherein said cooling fan control module selectively activates said cooling fan when said speed is less than a speed threshold and at least one of said coolant status signal has said first state and said component status signal has said second state.

6. The temperature control system of claim 1 wherein said component comparison module receives a plurality of electronic component temperatures including said electronic component temperature.

7. The temperature control system of claim 6 wherein said component comparison module determines a hottest temperature of said plurality of electronic component temperatures and generates said component status signal having said second state when said hottest temperature is greater than said second threshold.

8. The temperature control system of claim 1 further comprising one or more additional component comparison modules that each respectively receive an electronic component temperature, that each have a respective second threshold, and that each generate a respective component status signal having said second state when said respective received electronic component temperature is greater than said respective second threshold,
wherein said cooling fan control module activates said cooling fan when at least one of said coolant status signal has said first state, said component status signal has said second state, and any of said respective component status signals has said second state.

9. A method comprising:
generating a coolant status signal having a first state when a coolant temperature is greater than a first threshold;
generating a component status signal having a second state when an electronic component temperature is greater than a second threshold; and
selectively activating a cooling fan in a vehicle when at least one of said coolant status signal has said first state and said component status signal has said second state.

10. The method of claim 9 further comprising:
generating said coolant status signal having a third state when said coolant temperature is less than a third threshold;
generating said component status signal having a fourth state when said electronic component temperature is less than a fourth threshold,
wherein said third threshold is less than said first threshold and said fourth threshold is less than said second threshold; and
deactivating said cooling fan when said coolant status signal has said third state and said component status signal has said fourth state.

11. The method of claim 9 further comprising selectively activating said cooling fan based upon a speed of said vehicle.

12. The method of claim 11 further comprising selectively activating said cooling fan when said speed is less than a speed threshold and at least one of said coolant status signal has said first state and said component status signal has said second state.

13. The method of claim 9 further comprising receiving a plurality of electronic component temperatures including said electronic component temperature.

14. The method of claim 13 further comprising:
determining a hottest temperature of said plurality of electronic component temperatures; and
generating said component status signal having said second state when said hottest temperature is greater than said second threshold.

15. The method of claim 9 further comprising:
respectively receiving one or more additional electronic component temperatures, that each have a respective second threshold;
generating a respective component status signal having said second state for each of said respective received electronic component temperatures when said respective received electronic component temperature is greater than said respective second threshold; and
activating said cooling fan when at least one of said coolant status signal has said first state, said component status signal has said second state, and any of said respective component status signals has said second state.
